(19) United States
(12) Patent Application Publication
(10) Pub. No.: US 2013/0201572 A1
(43) Pub. Date: Aug. 8, 2013

(54) OPTICAL ELEMENT HOLDER

(71) Applicant: SIGMA KOKI CO., LTD., Saitama (JP)

(72) Inventors: Hideo YACHI, Ishikawa (JP); Katsunori HOSHIBA, Ishikawa (JP)

(73) Assignee: SIGMA KOKI CO., LTD., Saitama (JP)

(21) Appl. No.: 13/710,800

(22) Filed: Dec. 11, 2012

(30) Foreign Application Priority Data
Feb. 8, 2012 (JP) 2012-025296

(51) Int. Cl. G02B 7/182

(52) U.S. Cl. CPC G02B 7/182
USPC 359/872

(57) ABSTRACT

An optical element holder includes an optical element holding member that holds an optical element and a body disposed to face to the optical element holding member to support the optical element. The body is provided with a mount portion that mounts the body to a base. The mount portion and the optical element holding member are configured such that the optical element is located on an extension line of a center line of the mount portion.

### BACKGROUND OF THE INVENTION

1. Field of the Invention

The present invention relates to an optical element holder provided in an optical system and configured to hold an optical element such as a mirror to be able to adjust a tilt angle thereof.

2. Description of the Related Art

An optical device such as an interferometer is provided with a mirror to reflect light such as laser light to change its optical path in general. Heretofore, there has been known a mirror holder configured to hold such mirror in a condition of being able to adjust a tilt angle thereof so that the mirror can reflect the light with an adequate angle as disclosed in Japanese Patent Application Publication Nos. 2002-506998 and 2002-21835 for example.

As shown in FIGS. 4A and 4B, a mirror holder 1 as disclosed in JP2002-506998A and JP2002-21835A includes a body 3 having a fixing shaft 2, i.e., a mount portion, for mounting the mirror holder 1 to a base such as a vibration isolation table not shown, and a mirror holding member 6 configured to integrally hold a mirror 5 and disposed so as to face to the body 3. The mirror holder 1 is configured to control a tilt angle of the mirror 5 with respect to the body 3 centering on a fulcrum portion 9 by moving adjusting screws 8 forward/backward against a biasing force of a tensile coil spring 7 disposed between the body 3 and the mirror holding member 6.

However, the mirror holder 1 as disclosed above has problems that because a reflection surface 5a of the mirror 5 is offset from the fixing shaft 2 by a predetermined distance (e) , it is necessary to calculate a fixing position of the mirror in setting the device and extra workload is required in controlling the tilt angle of the mirror in installing the device.

Still further, although it is conceivable to eliminate such offset between the mirror and the mount portion by adding a plate between the base and the mirror holder to shift the mirror holder to the plate by the predetermined distance (e) and to fix the mirror holder to the plate, a spectral axis is heightened by a thickness of the plate, so that stability of the mirror holder 1 drops while increasing the size and cost thereof.

### SUMMARY OF THE INVENTION

The present invention provides an optical element holder including a body including a mount portion that mounts the body to a base, an optical element holding member disposed to face to the body and configured to integrally hold an optical element, a fulcrum portion that supports the optical element holding member tiltably with respect to the body, an adjusting screw that is screwed into either one of the optical element holding member and the body and whose edge abuts another one to adjust a tilt angle of the optical element holding member with respect to the body, and a biasing member that biases the optical element holding member and the body such that the optical element holding member and the body abut through an intermediary of the fulcrum portion and the adjusting screw, wherein the mount portion and the optical element holding member are disposed such that the optical element is located on an extension line of a center line of the mount portion.

Further features of the present invention will become apparent from the following description of exemplary embodiments (with reference to the attached drawings).

### BRIEF DESCRIPTION OF THE DRAWINGS

FIGS. 1A through 1F are schematic diagrams showing a mirror holder of an embodiment of the invention, wherein FIG. 1A is a front view of the mirror holder;

FIG. 1B is a left side view of the mirror holder;

FIG. 1C is a plan view of the mirror holder;

FIG. 1D is a back view of the mirror holder;

FIG. 1E is a bottom view of the mirror holder; and

FIG. 1F is a section view taken along a line A-A in FIG. 1A;

FIGS. 2A and 2B are diagrams showing a state in which the mirror holder of the embodiment is fixed to a rod, wherein FIG. 2A is a front view thereof; and

FIG. 2B is a section view taken along a line B-B in FIG. 2A;

FIGS. 3A and 3B are diagrams showing a state in which the mirror holder of the embodiment is fixed by a screw, wherein FIG. 3A is a front view thereof; and

FIG. 3B is a section view taken along a line C-C in FIG. 3A;

FIGS. 4A and 4B show a prior art mirror holder, wherein FIG. 4A is a front view of the mirror holder; and

FIG. 4B is a right side view of the mirror holder.

### DESCRIPTION OF THE EMBODIMENTS

Embodiments of an optical element holder of the invention will be explained below with reference to the drawings.

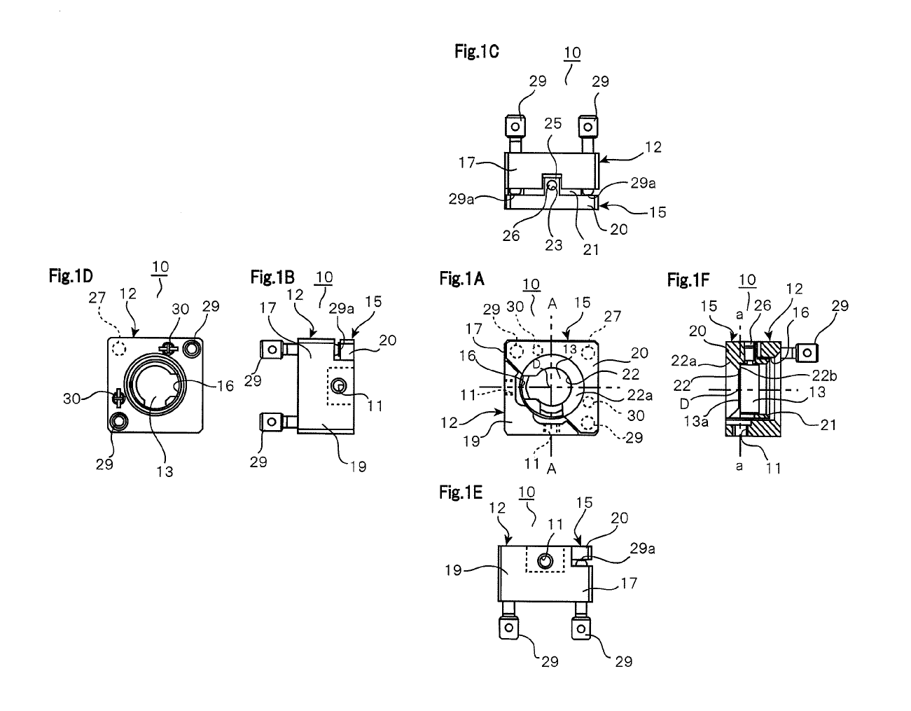

As shown in FIGS. 1A through 1F, the optical element holder 10, i.e., a mirror holder, includes a body 12 having a mount portion 11 for mounting the body 12 to a base not shown such as a vibration isolation table of an interferometer for example, and a mirror holding member 15, i.e., an optical element holding member, that is disposed so as to face to the body 12 and integrally holds a mirror 13, i.e., an optical element.

The body 12 is formed into a rectangular shape when seen from a front side thereof and has a cylindrical hole 16 at a center part thereof. The body 12 includes a thin portion 17 and a thick portion 19. The thin portion 17 is machined substantially into a shape of a right-angled triangle along a diagonal line of the rectangle described above and is disposed at one side with respect to the diagonal line of the rectangle. The thick portion 19 is formed at part of the rectangle other than the thin portion 17.

It is noted that the substantially right-angled triangle described above is not strictly limited to be a triangle and may be a deformed pentagon. That is, the thin portion may be formed into a shape including two sides that sandwich one corner of the rectangle and corner portions at edges of the two sides by machining the rectangle body by leaving one last corner side of the rectangle. The remaining triangular part of the rectangle having the one last corner may be formed as the thick portion.

As shown in the front or plan view of the mirror holding member 15, the mirror holding member 15 has a plate-like portion 20 formed substantially into a triangular shape, and a cylindrical portion 21 formed integrally with the plate-like portion 20 and extends in a back direction. A hole 22 is perforated through the mirror holding member 15 on a side opposite the cylindrical portion 21 of the plate-like portion 20 so as to have a tapered expanding surface 22a whose circumference is partly cut away. The cylindrical portion side of the hole 22 is formed as a stepped portion 22b and is connected to the cylindrical portion 21. A projection 25 having a female screw is provided so as to project in an axial direction above the cylindrical portion 21. The mirror 13 is fitted into the cylindrical portion 21 and the side of a reflecting surface 13a thereof is positioned in the stepped portion 22b. Then, the mirror 13 is fixed by the mirror holding member 15 by a fixing screw 26 screwed into the female screw 23.

The body 12 and the mirror holding member 15 are formed into a rectangular parallelepiped shape substantially having a square shape when seen from the front thereof as a whole by fitting the cylindrical portion 21 of the mirror holding member 15 into the cylindrical hole 16 of the body 12 and by disposing the plate-like portion 20 of the mirror holding member 15 so as to face to the thin portion 17 of the body 12.

Fulcrum portions 27 that support the mirror holding member 15 tiltably with respect to the body 12 are disposed at apex (right angle) portions of the right-angled triangle of the thin portion 17 and the plate-like portion 20. The fulcrum portions 27 are composed of concave portions each formed into an inverted circular cone and disposed so as to face to each other in the body 12 and the mirror holding member 15 and a ball sandwiched in each of the concave portions.

The adjusting screws 29 are screwed toward the mirror holding member from the back side opposite from a surface that faces to the mirror holding member at corners separated from the apex portion of the two sides interposing the apex portion where the fulcrum portion 27 of the thin portion 17 of the body 12 is disposed. The adjusting screws 29 press the plate-like portion 20 as the edges 29a abut the plate-like portion 20 of the mirror holding member 15.

As shown in the front and back views, i.e., in FIGS. 1A and 1D, tensile coil springs (biasing member) 30 are disposed so as to bias the body 12 and the member 15 between the fulcrum portion 27 and the adjusting screws 29 so that the body 12 abuts the mirror holding member 15 through the intermediary of the fulcrum portion 27 and the adjusting screws 29.

The mount portions 11 for mounting the body 12 to the base are disposed on the thick portion 19 of the body 12. The two mount portions 11 are provided to mount in horizontal and vertical directions, and extension lines of center lines of the mount portions cross at right angles at a center D of the mirror 13.

As shown in the front and back views, i.e., in FIGS. 1A and 1D, the mount portions 11 are disposed on the side opposite the tensile coil springs 30 in terms of the mirror 13. The mount portions 11 and the tensile coil springs 30 do not interfere from each other. Still further, because the body 12 and the mirror holding member 15 are also combined and formed into the rectangular parallelepiped shape as a whole, it is possible to downsize the mirror holder 10. Then, because the mirror 13 is disposed at the position close to the base due to the downsizing, the mirror 13 can be held stably.

The mirror 13 is disposed so that the center D of the reflecting surface 13a of the mirror 13 is substantially positioned on the extension line a-a of the center line of the mount portion 11, so that a light reflecting position caused by the reflecting surface 13a is located substantially on the extension line a-a of the center line of the mount portion 11 (see FIG. 1F).

Next, operations of the mirror holder 10 of the present embodiment constructed as described above will be explained below. That is, the tensile coil springs 30 bias the mirror holding member 15 to the edges 29a of the adjusting screws 29 that are screwed into the body 12 and the fulcrum portion 27, and the body 12 supports the mirror holding member 15 by these three points.

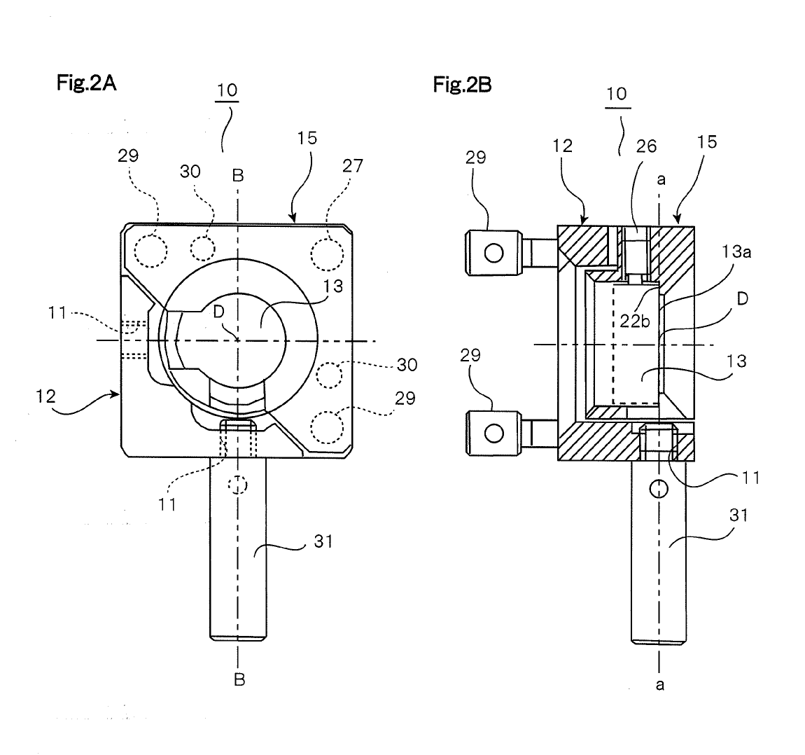

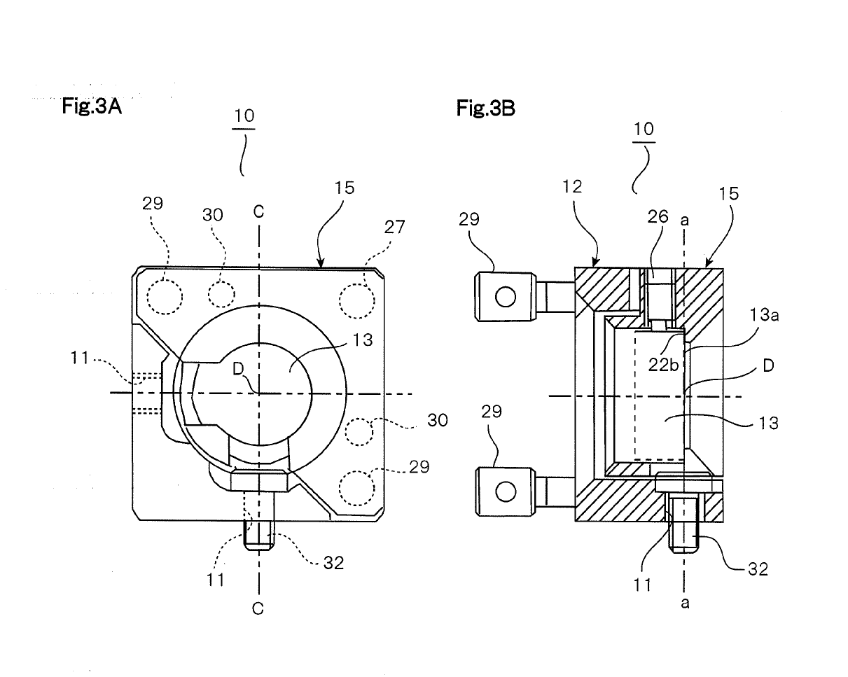

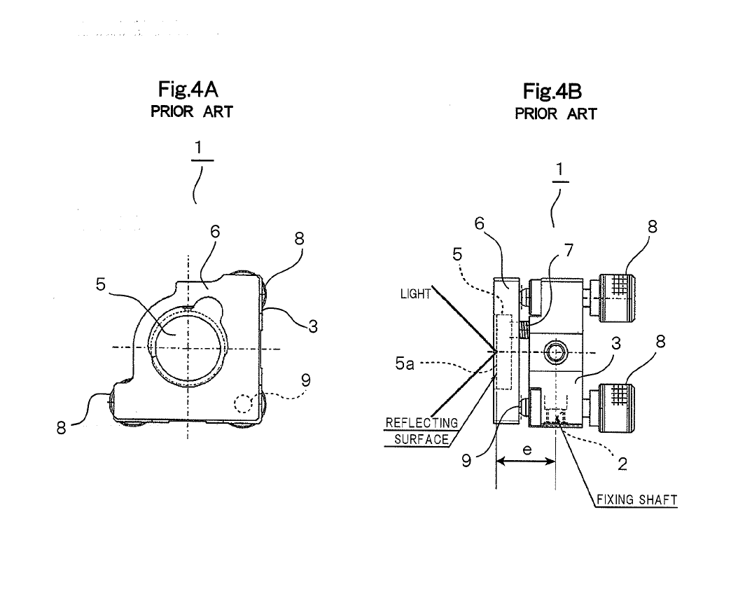

A condition in which the reflecting surface 13a of the mirror 13 mounted to the mirror holding member 15 is vertical with respect to the adjusting screws 29 will be assumed to be a neutral position hereinafter. Then, when the mirror 13 is in the neural position, the mirror holder 10 is fixed by screwing the rod 31 to the mount portion 11 from the underneath thereof as shown in FIG. 2 or mounted to a base of various optical devices by the mounting screw 32 from above as shown in FIG. 3 to be disposed on the optical path of the optical device.

The center D of the reflecting surface 13a of the mirror 13 is located on the extension line a-a of the center line of the mount portion 11, the rod 31 or the mounting screw 32 in this condition, so that the installation position of the mount portion 11 and of the reflecting surface 13a of the mirror 13 are located on the same plane on the optical path.

Next, the adjusting screws 29 that are screwed into the body 12 are turned against the biasing force of the tensile coil springs 30 to press the plate-like portion 20 of the mirror holding member 15, and the tilt angle of the mirror holding member 15 and the mirror 13 is controlled to a desirable angle by the fulcrum of the fulcrum portion 27. Even if the tilt angle of the mirror 13 is changed from the neutral position, a move of the center D of the reflecting surface 13a of the mirror 13 with respect to the extension line a-a of the center line of the mount portion 11 is very small, and the extension line a-a and the center D are approximated so as to be located on the same axis. Still further, it is possible to locate the mount portion 11 coaxially with the center D of the reflecting surface 13a by controlling the mutual advance/setback position of the two adjusting screws 29.

Accordingly, the extension line a-a of the center line of the mount portion 11 is located in the vicinity of the center D of the reflecting surface 13a of the mirror 13 even if the tilt angle of the mirror 13 with respect to the body 12 is changed from the neutral position, so that it is not necessary to calculate the fixing position of the mirror 13 and the optical path in setting the optical device. Then, it is possible to dispose the optical element readily in the optical device and to readily control the tilt angle of the mirror 13 by the mirror holder 10.

That is, because the optical element is disposed on the extension line of the center line of the mount portion to be mounted to the base and the installation position on the optical path of the mount portion and the optical element coincide, it is not necessary to calculate the fixing position of the optical element and the optical path in setting the optical device. Then, it is possible to reduce a workload for controlling the tilt angle of the optical element and to dispose the optical element readily in the optical device. Still further, because the optical element is directly mounted to the base in the mount portion of the body, it is possible to dispose the optical element while downsizing the device, keeping a low optical axis and maintaining the high stability.

Still further, because the reflecting surface of the mirror is substantially located on the extension line of the center line of the mount portion, and the installation position of the mount portion and the reflecting surface of the mirror on the optical path coincide, it is not necessary to calculate the fixing position of the mirror and the optical path in setting the optical device. Then, it is possible to reduce the workload for controlling the tilt angle of the mirror and to dispose the mirror readily in the optical device.

Furthermore, because the mount portion and the biasing member are disposed on the sides opposite from each other while interposing the optical element therebetween, the mount portion does not interfere with the biasing member and the device can be downsized.

Still further, because the thin portion of the body is disposed so as to face to the plate-like portion of the optical element holding member and the mount portion is disposed at the thick portion other than the thin portion of the body, it is possible to form the optical element holder compactly into the rectangular parallelepiped shape as a whole. It is also possible to improve the stability by disposing the optical element at the position close to the base by downsizing the optical element holder.

Still further, because the adjusting screws are screwed into the body and the mass of the adjusting screws affects the body, the tilt angle of the optical element can be held stably.

It is noted that the mirror holding member 15 described above is not limited to hold the mirror 13 and may hold other optical elements such as a lens, a prism, an optical filter and others. When the optical element is a convex lens for example, it is disposed so that its center surface corresponds to the position of the reflecting surface of the mirror described above.

While the adjusting screws 29 are disposed by screwing into the body 12 in the embodiment described above, these adjusting screws 29 may be screwed into the mirror holding member 15 and the edge thereof may be abutted the body 12 so that the tilt angle of the mirror holding member 15 and the mirror 13 can be freely controlled.

It is also possible to dispose a magnet that attracts the both the body 12 and the mirror holding member 15, instead of the tensile coil springs 30, as a means for biasing the mirror holding member 15 to the body 12.

The thin portion 17 and the plate-like portion 20 disposed so as to face to the thin portion 17 may not be limited to be right triangle. For instance, the opposite sides of the apex part where the fulcrum portion 27 is disposed may be stepped or curved, instead of being straight, and may be any shape as long as the combined shape of the body 12 and the mirror holding member 15 is substantially a rectangular parallelepiped shape.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-025296, filed on Feb. 8, 2012, which is hereby incorporated by reference herein in its entirety.

What is claimed is:

1. An optical element holder, comprising:
a body including a mount portion that mounts the body to a base;
an optical element holding member disposed to face to the body and configured to integrally hold an optical element;
a fulcrum portion that supports the optical element holding member tiltably with respect to the body;
an adjusting screw that is screwed into either one of the optical element holding member and the body and whose edge abuts another one to adjust atilt angle of the optical element holding member with respect to the body; and
a biasing member that biases the optical element holding member and the body such that the optical element holding member and the body abut through an intermediary of the fulcrum portion and the adjusting screw;
wherein the mount portion and the optical element holding member are disposed such that the optical element is located on an extension line of a center line of the mount portion.

2. The optical element holder according to claim 1, wherein the optical element is a mirror, and a reflection surface of the mirror is located substantially on the extension line of the center line of the mount portion.

3. The optical element holder according to claim 1, wherein the mount portion is located on a side opposite from the biasing member by interposing the optical element therebetween.

4. The optical element holder according to claim 1, wherein the body is formed into a rectangular shape when seen from a front thereof, has a cylindrical hole at a center part thereof, and has a thin portion formed at one side with respect to a diagonal line of the rectangle;
the optical element holding member includes a plate-like portion disposed to face to the thin portion and a cylindrical portion holding the optical element by fitting into the cylindrical hole;
the body and the optical element holding member are combined and are formed into a rectangular parallelepiped shape; and
the mount portion is disposed at a thick portion other than the thin portion of the body.

5. The optical element holder according to claim 1, wherein the adjusting screw is screwed into the body.
